(19) United States
(12) Patent Application Publication
(10) Pub. No.: US 2008/0150837 A1
(43) Pub. Date: Jun. 26, 2008

(54) Plasma display apparatus

(76) Inventor: Michitaka Ohsawa, Fujisawa (JP)

Correspondence Address: MCDERMOTT WILL & EMERY LLP, 600 13TH STREET, N.W., WASHINGTON, DC, 20005-3096, US

(21) Appl. No.: 11/896,475

(22) Filed: Aug. 31, 2007

(30) Foreign Application Priority Data
Dec. 26, 2006 (JP) 2006-348744

(51) Int. Cl. G09G 3/28

(52) U.S. Cl. 345/60

(57) ABSTRACT

For providing a plasma display apparatus of driving a large-sized PDP thereof, with using a sustain discharge drive waveform for enabling to obtain a high light-emission efficiency, which is made up with a narrow-width pulse of high-voltage and a wide-width pulse of low-voltage accompanying with this, a sustain pulse, to be applied between the sustain discharge electrodes during sustain period, is constructed with a base pulse (P2) and a superpose pulse (P1) to be superposed at a front end portion of this base pulse (P2). The superpose pulse (P1) also has voltage (Vp) for starting the sustain discharge and difference voltage (Vdif) from voltage (Vsu) for stopping the sustain discharge through forming wall electric charges, and further pulse width (T1) shorter than a time-period from staring of the sustain discharge up to self-stoppage thereof. Also, the base pulse (P2) has pulse width (Ts) equal to a sum of the above-mentioned T1 and T2 larger than this T1, and it has the voltage (Vsu) mentioned above.

### BACKGROUND OF THE INVENTION

The present invention relates to a plasma display apparatus, applying an AC-type (i.e., an alternating current type) plasma display panel therein, and it also relates, in particular, to a driver circuit for driving the plasma display panel with a sustain pulse, which is formed with a narrow-width pulse of high-voltage and a wide-width pulse of low voltage, following therewith, during a period of discharging the sustain pulse, for the purpose of an improvement of luminous or light-emission efficiency of the plasma display panel.

Conventionally, within a plasma display panel (hereinafter, being called “PDP”), in particular, within an alternating current type (i.e., AC-type) PDP, for the purpose of achieving an improvement in the discharge efficiency during the period of sustain discharging (i.e., a sustain period), a technology is disclosed, for example, in the following Patent Document 1, for achieving an improvement on a waveform of the discharge sustain pulse (i.e., a sustain pulse) to be applied across a scanning electrode (“Y” electrode) and a common electrode (“X” electrode or a sustain electrode) during the sustaining period.

The sustain discharge pulse disclosed in the Patent Document 1 is constructed with a first voltage pulse and a second voltage pulse. The first voltage pulse has a voltage level, being sufficient for starting the discharge, and due to generation of the reversed electric field, which is generated by the wall electric charges formed with this discharge, it has a pulse width, being shorter than a time-period during when the discharge reaches to stop by itself (for example, approximately, 0.6 μS) (hereinafter, being called “narrow-width pulse”). The second voltage pulse has a voltage level, being lower than the voltage for enabling to continue the discharge that is generated by the narrow-width pulse mentioned above, and it has a pulse width, so that a part of space electric charges produced through the discharge, which is generated by the narrow-width pulse, can adhere, in the form of the wall electric charges (for example, approximately, 2-3 μS) (hereinafter, being called “wide-width pulse”).

An example of a circuit for forming such the sustain pulse is disclosed, for example, in the following the Patent Document 2. The Patent Document 2 discloses therein to build up a series connection of capacities “Cpanel”, owned by a switch “p1”, a coil “L” and a PDP (hereinafter, being called a “panel capacity”), from a direct current source SVp, and to generate voltage, being two (2) times large as the power source voltage SVp, at the sustain electrode, with using the resonance operation of charging the panel capacity “Cpanel” from the power source SVp through the coil “L”.

[Patent Document 1] Japanese Patent No. 2876688; and

[Patent Document 2] Japanese Patent Laying-Open No. 2001-13919 (2001).

### BRIEF SUMMARY OF THE INVENTION

In case when adapting the technology described in the Patent Document 1 into a PDP of 42 inches, for example, in particular, for the purpose of supplying discharge current (of several tens Amperes, at peak) during that period while applying it onto the panel capacity (about 0.05 μF by dividing the sustain electrodes of 42 inches into two (2) in the vertical direction), it is necessary to charge the panel capacity up to around 160 V during rise-up time of 0.1-0.2 μS, thereby to discharge it thereafter. For that purpose, there is a necessity of a semiconductor switch having a quick ON/OFF speed, but it is not easy to achieve this. In general, with the semiconductor, the quicker the ON/OFF speed, the lower the withstand voltage thereof, and it is expensive to achieve such a high-speed and large-current semiconductor exceeding the withstand voltage 150 V, and therefore it is difficult to obtain an IC including it therein.

On the other hand, in the Patent Document 2, a LC series-connected resonance circuit is constructed with the coil “L” and the panel capacity “Cpanel”, thereby to form the narrow-width pulse with using the resonance phenomenon, however in this series-connected resonance circuit is included a parasitic resistance “R” therein, existing within an actual sustain electrodes. The parasitic resistance “R”, existing within the actual sustain electrodes, comes to be large as the PDP becomes large in the size thereof, and for example, it can be thought to have the resistance from several to several tens Ω, in the panel of 42 inches. When the parasitic resistance “R” is large, “Q (Quality factor: ωL/R)” comes to be small, and then it is difficult to produce such the narrow-width pulse, having the voltage value of about 160 V, for example. Accordingly, it is difficult to apply the technology for producing the narrow-width pulse with using the LC series-connected resonance circuit, in particular, in case where the PDP becomes large in the size thereof, for example, exceeding 42 inches, for example.

In accordance with the present invention, accomplished by taking the problems mentioned above into the consideration thereof, an object thereof is to provide a technology for driving a large-size PDP with using the narrow-width pulse, preferably, within the plasma display apparatus.

For accomplishing the object mentioned above, a plasma display apparatus, according to the present invention, for generating a sustain pulse, which is built up with a narrow-width pulse (pulse width t1, voltage Vp) and a wide-width pulse (pulse width t2, voltage Vsu), comprises a base pulse generating portion, for generating a base pulse, having voltage Vsu and pulse width (t1+t2), and a superpose pulse producing portion for producing superpose pulse having voltage (Vp−Vsu) and pulse width t1, to be superpose at a front end portion of the base pulse.

Also, according to the present invention, a reference potential of the superpose pulse producing portion mentioned above may be floated with respect to a reference potential of the base pulse generating portion mentioned above.

With this, the peak value voltage (Vp-Vsu) of the superpose pulse can be made small, and it is possible to produce the superpose pulse with using a semiconductor switch of enabling high-speed operation (for example, a MOS transistor for use of high-speed switching). Accordingly, even for a large-sized PDP, it is possible to produce a suitable sustain pulse, but without using the LC series-connected resonance circuit. Also, since control can be achieved thereon, with using an active element for the purpose of waveform generation, the waveform can be adjusted for the purpose of optimization of operations thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIGS. 1(a) to 1(d) are views for explaining waveforms of driving voltage of a PDP during a sustain period, within a plasma display apparatus, according to an embodiment of the present invention;

FIG. 2 is a block diagram for showing the structures of a PDP drive portion, within the PDP apparatus, according to an embodiment 1;

FIG. 3 is a circuit diagram for showing the principle portion of a “Y” drive portion, according to the embodiment 1;

FIG. 4 is a circuit diagram for showing the principle portion of a “Y” drive portion, according to the embodiment 1;

FIG. 5 a view for showing timing waveforms and output waveforms at portions thereof, for explaining the operations the drive circuits, within the embodiment 1; and

FIG. 6 is a circuit diagram for showing the principle portion of a “Y” drive portion, according to the embodiment 2.

### DETAILED DESCRIPTION OF THE INVENTION

Hereinafter, embodiments according to the present invention will be fully explained by referring to the attached drawings. However, in all of those figures, a portion having a common function is shown by attaching a same reference numeral, and repetitive explanation will be omitted from, on that once explained, for the purpose of escaping from complication thereof.

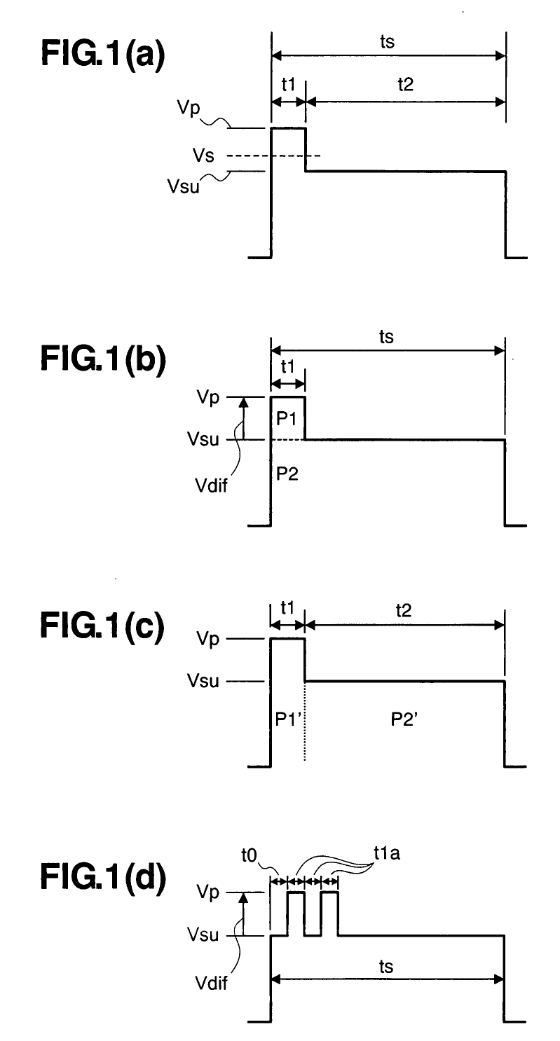

First of all, explanation will be made on the outline of the present embodiment, by referring to FIG. 1. This FIGS. 1(a) to 1(d) are views for explaining the waveforms of driving voltages of PDP, within sustain period of a plasma display apparatus, according to the present invention.

The waveform of the driving voltage shown in FIG. 1(a) is that of the driving voltage, in particular, in case when constructing it by combining the narrow-width pulse and the wide-width pulse, which are disclosed in the Patent Document 1, as a sustain pulse. Such sustain pulse is constructed with, as is shown in FIG. 1(c), the narrow-width pulse P1′ and the wide-width pulse P2′. The narrow-width pulse P1′ has high-voltage Vp sufficient for starting sustain discharge. Further, from the beginning of the sustain discharge, it also has a pulse width t1, being shorter than the period up to when the sustain discharge stops itself due to generation of the reverse electric field, which is generated by wall electric charges formed with the sustain discharge. Also, the wide-width pulse P2′ is lower than the voltage for enabling to continue the sustain discharge, which is generated by the narrow-width pulse P1′, and further has such a low voltage Vsu that a part of the space discharges produced due to the sustain discharge can adhere in the form of the wall electric charges. Furthermore, the wide-width pulse P2′ has a pulse width t2 longer than the pulse width t1. However, voltage Vs is the voltage level of the conventional sustain pulse (pulse width ts: normally, about 2 to 3 μS) to be applied onto the PDP for starting the sustain discharge, and in general, it is set at around 160 to 220 V, for the PDP of 42 inches.

According to the present embodiment, as is shown in FIG. 1(b), the waveform of the driving voltage mentioned above is constructed with the wide-width pulse, having the low voltage Vsu and pulse width (ts=t1+t2) (hereinafter, being called a “base pulse”), and the narrow-width pulse, being superposed at a front end portion of this base pulse and having voltage (Vp−Vsu) and pulse width t1 (hereinafter, being called a “superposed pulse”). Although the details of circuitry thereof will be mentioned later, but for the purpose of superimpose the superposed pulse P1 on the base pulse P2, it is necessary to float a reference potential (a virtual GND) of a superposed pulse producer portion for producing the superposed pulse, with respect to a reference potential (GND) of a base pulse producer potion for producing the base pulse P2.

The base pulse P2, being the wide-with pulse, is nearly equal to the sustain pulse according to the conventional technology, and it can be produced by the conventional sustain circuit. Also, the superposed pulse P1, being the thin-with pulse, may be that having amplitude of voltage of voltage difference Vdif between the voltage Vp and the voltage Vsu. For this reason, it is possible to suppress the voltage level of the superposed pulse P1 to be small, sufficiently. Accordingly, it is possible to apply the IC technology of integrating the semiconductor elements of fast switching speed.

As was mentioned above, according to the present embodiment, the peak value voltage (Vdif=Vp−Vsu) of the superposed pulse P1 can be made small, and also the superposed pulse can be produced with using the semiconductor (for example, a MOS transistor), therefore it is possible to build up the circuits with the IC circuit.

Further, with the embodiment, which will be mentioned below, a plural number of narrow-width pulses are used as the superposed pulse, as is shown in FIG. 1(d). Herein, for an example, two (2) pieces of the narrow-width pulses are piled up or superposed, each having the pulse width t1a=100 nS, and amplitude of 60 to 70 V, which also enables the IC circuit thereof, as one example. However, it is needless to say that the present invention should not be restricted to this.

As is described in the Patent Document 1, the luminous or light-emission efficiency can be improved, as the pulse width comes to be narrow. However, since the pulse width is narrow, there is a possibility of lowering the brightness. Then, according to the present embodiment, the narrow-width pulses are piled up with, in plural number thereof (herein, two (2) pieces thereof), so as to cause the discharge in a plural number of times (herein, two (2) times), thereby brining the brightness to be nearly equal to that of the conventional art. Thus, filing up the plural number of narrow-width pulses enables to obtain the brightness nearly equal to that of the conventional art, while achieving an improvement on the light-emission efficiency.

Also, according to the present embodiment, it is also possible to file up a front superpose pulse, after passing a predetermined time-period t0 from the front end of the base pulse (i.e., a rise-up point), thereby enabling a free setup of the discharge configuration, fitting to the request from the system.

### Embodiment 1

Next, explanation will be made on a plasma display apparatus (hereinafter, being abbreviated by “PDP apparatus”) with using a AC-type PDP therein, according to one embodiment of the present invention. However, the present embodiment relates to a driving method of the sustain electrodes, building up a pair of a “Y” electrode and an “X” electrode when the PDP conducts the sustain discharge. Accordingly, though explanation will be made on PDP peripheral driver portions for driving the PDP, in the below, briefly about the driving operations during a reset period or an address period, but the detailed exaltation will be made in relation to the driving operations for the sustain discharges.

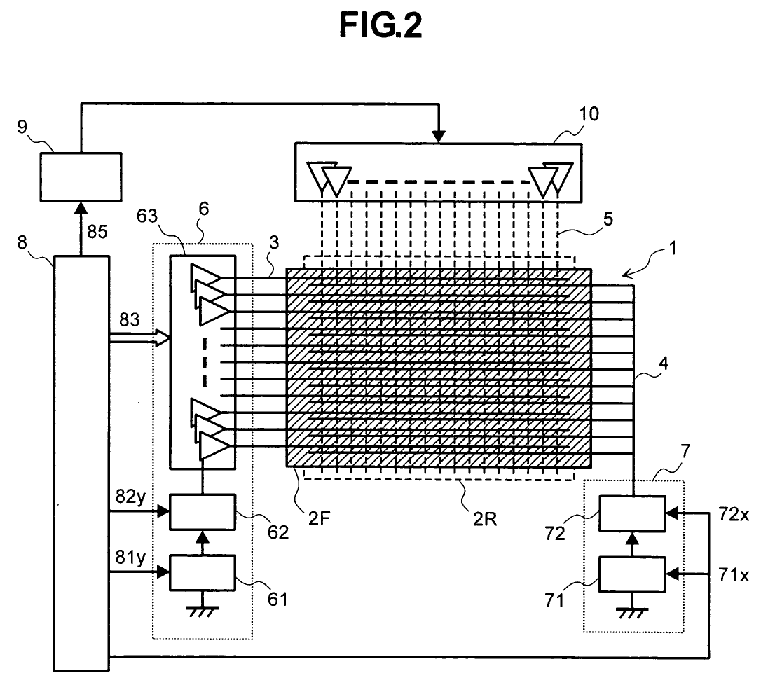

FIG. 2 is a block diagram for showing the structures of a PDP driver portion within the PDP apparatus, according to the embodiment 1 of the present invention.

As is shown in FIG. 2, the PDP peripheral driver portions includes a PDP 1, a “Y” driver portion 6, being the one of sustain discharge drive circuits, for driving the PDP 1 from the side of “Y” electrodes 3, an “X” driver portion 7, being the other of sustain discharge drive circuits, for driving the PDP 1 from the side of “X” electrodes 4, a timing controller portion 8, a video processor portion 9, and an address driver portion 10.

The PDP 1 comprises a front surface plate 2F and a rear surface plate 2R, which are disposed opposing to each other. The front surface plate 2F comprises a plural number of pairs of the “Y” electrodes and the “X” electrodes, building up the sustain electrodes. The plasma display apparatus can be seen from the lights emitting through the front surface plate 2F thereof. The “Y” electrodes 3 and the “X” electrodes 4 are made of metal electrodes, such as, silver or gold, and transparent electrodes, such as, ITO or the like, being laminated in a stripe-like manner, and a dielectric substance (not shown in the figure, but mainly composed of glass) is so disposed that it covers those electrodes.

On the rear surface plate 2R are formed with address electrodes (hereinafter, being called an ““A” electrode(s)”), so that they cross the “Y” electrodes 3 and the “X” electrodes 4 at the right angles.

And, at an intersection point between the pair of sustain electrodes (i.e., the “Y” electrode 3 and the “X” electrode 4) and each of the “A” electrodes is built up a display cell (not shown in the figure), to be a pixel, respectively.

The timing controller portion 8 produces various kinds of timing signals, upon basis of sync signal from a sync signal extracting circuit not shown in the figure. As those various kinds of timing signals are produced the following; for example, an address electrode control signal (hereinafter, being called an ““A” electrode control signal”) 85 for controlling the “A” electrode fitting to a “Y” electrode scan of the address period, a sustain control signal for conducting sustain discharge drive, etc. The sustain control signal includes base pulse control signals 81y, 71x for controlling production of the base pulse P2, and superpose pulse control signals 82y and 72x for controlling production of the superpose pulse P1.

The Y driver portion 6, being the one of sustain discharge drive circuits, includes a “Y” sustain circuit 61, as a base pulse producer portion for producing the base pulse P2 to be applied onto the “Y” electrode, a “Y” superpose pulse producing circuit 62, as a “Y” superpose pulse producer portion for producing the superpose pulse P1, and a scan circuit 63, therein.

The scan circuit 63 performs scanning of the “Y” electrodes 3 during the address period, upon basis of the scan control signal 83 from the timing controller portion 8.

The “Y” sustain circuit 61, upon receipt of the base pulse control signals 81y from the timing controller portion 7, produces the base pulse P2 for driving the “Y” electrodes 3 into the sustain discharge during the sustain period.

Also, the “Y” superpose pulse producing circuit 62, upon receipt of the superpose pulse control signal 82y from the timing controller portion 7, produces the superpose pulse P1, and as is shown in FIG. 1(d), it superimposes the superpose pulse P1 produce at the front end portion of the base pulse P2. The reference potential (the virtual GND) of the “Y” superpose pulse producing circuit 62 is floated with respect to the reference potential (the reference GND) of the “Y” sustain circuit 61, for the purpose of superimposing the superpose pulse P1 on the base pulse P2 (the details thereof will be mentioned later).

The “X” driver portion 7, being the other of sustain discharge drive circuits, includes an “X” sustain circuit 71, as a base pulse producer portion for producing the base pulse P2 to be applied onto the “X” electrodes, and an “X” superpose pulse producing circuit, as the superpose pulse producer portion for producing the superpose pulse P1, therein.

The “X” sustain circuit 71, upon receipt of the base pulse control signal 81x from the timing controller portion 7, produces the base pulse P2 for driving the “X” electrodes 4 into the sustain discharge during the sustain period.

Also, the “X” superpose pulse producing circuit 72, upon receipt of the superpose pulse control signal 82x from the timing controller portion 7, produces the superpose pulse P2, and as is shown in FIG. 1(d), it superimposes the superpose pulse P1 produce at the front end portion of the base pulse P2. The reference potential (the virtual GND) of the “X” superpose pulse producing circuit 72 is also floated with respect to the reference potential (the reference GND) of the “X” sustain circuit 71, for the purpose of superimposing the superpose pulse P1 on the base pulse P2 (the details thereof will be mentioned later).

The video processor portion 9 converts 1 field data of the video data (not shown in the figure) inputted, into a plural number of sub-field data. And, it supplies them to the address driver portion 10, upon basis of the “A” electrode control signal 85 from the timing controller portion 8.

The address driver portion 10 applies the address pulse (not shown in the figure) to the “A” electrode 5 corresponding to the display cell to be lighten during the sustain period, synchronizing the signal from the video processor portion 9 with the scanning (i.e., a line scanning) by a scan circuit 63 of the “Y” driver portion 6.

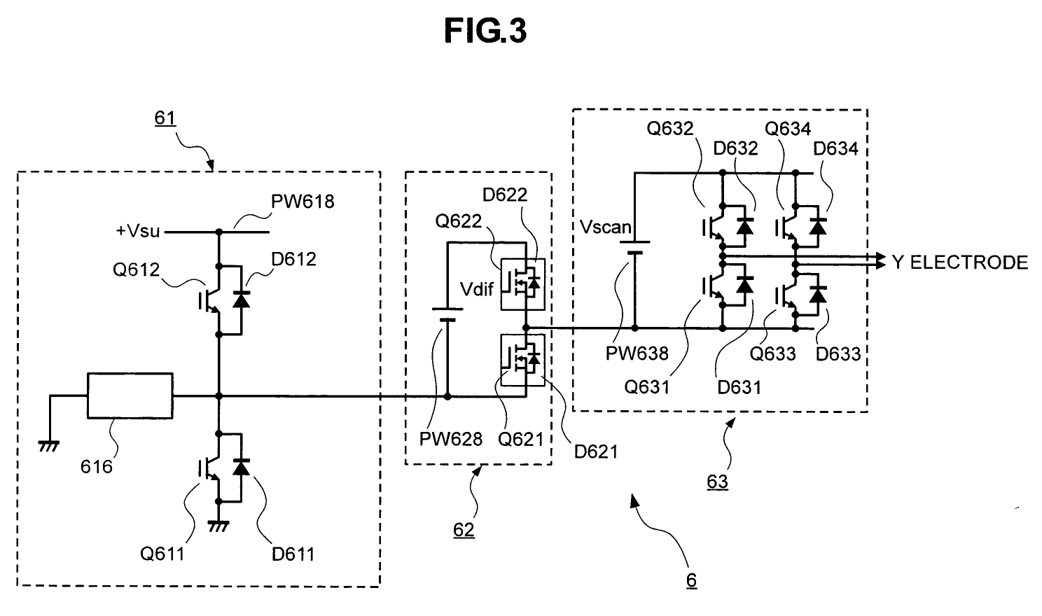

Next, by referring to FIGS. 3, 4 and 5, explanation will be made on the embodiments of the “Y” driver portion 6 and the “X” driver potion 7, being the drive circuits for producing the driving waveforms of sustain discharges, so as to increase the light-emission efficiency shown in FIG. 1(d).

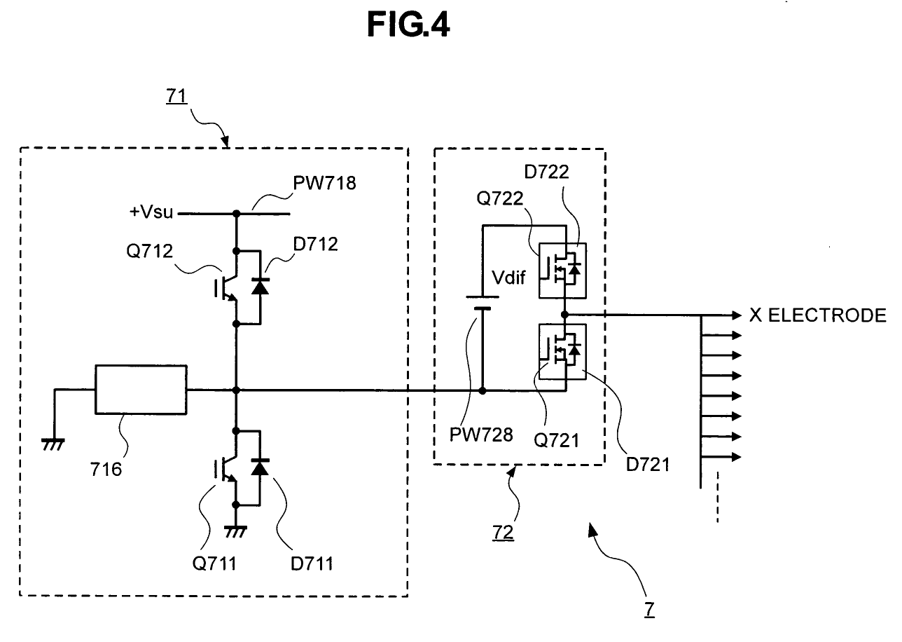

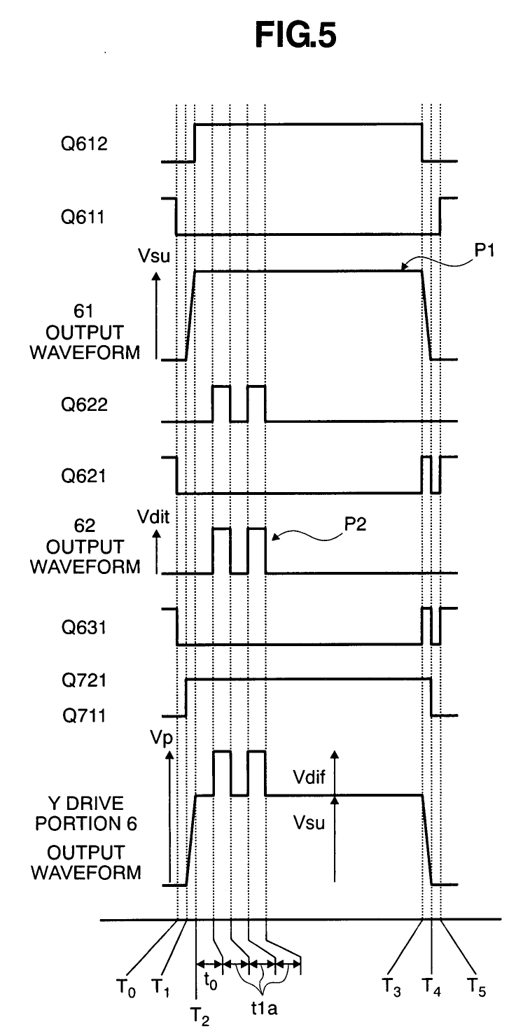

FIG. 3 shows the circuit structures, for showing a principle portion, diagrammatically, of the “Y” driver portion 6, according to the present embodiment, FIG. 4 for showing a principle portion, diagrammatically, of the “X” driver portion 6, according to the present embodiment, and FIG. 5 shows timing waveforms and output waveforms of the respective portions thereof, for explaining the operations of the drive circuits, according to the present embodiment.

However, in FIGS. 3 and 4, for the purpose of easy understanding, illustration is made on only an output stage of each of the circuits. And, the scan circuit shown in FIG. 3 has the number of output stages, being same to that of the “Y” electrodes, for driving each of “Y” electrode, but only two (2) output stages are shown, herein, for the convenience, and the operations thereof will be explained by referring only one (1) output stage (herein, an output stage constructed with a transistor Q631 and Q632). Also, the operation of the “Y” driver portion 6 is same to that of the “X” driver portion 7, during the sustain period, and therefore, hereinafter, explanation will be made on the operations of the drive circuit in case when driving the PDP 1 from the side of “Y” electrode.

As is shown in FIG. 3, the “Y” sustain circuit 61 for producing the base pulse includes therein, a power source PW618 (power source voltage Vsu), an electric power collecting circuit 616, and transistors Q611 and Q612 for use of switching. Also, the “Y” superpose pulse producing circuit 62 for producing the superpose pulse includes therein, a floating power source PW628 (i.e., the power source voltage Vdif with respect to the virtual GND of the “Y” superpose pulse producing circuit 62), and transistors Q621 and Q622 for use of switching. Also, the scan circuit 63 for conducting the scan during the address period includes therein, a floating power source PW638 (i.e., the source voltage Vscan with respect to the virtual GND of the scan circuit 63), and transistors Q631, Q632, Q633, Q634 . . . for use of switching. And across each of the switching transistors is connected a diode indicated by the reference numerals, D631, D632, D633, or D634.

In the similar manner, as is shown in FIG. 4, the “X” sustain circuit 71 for producing the base pulse includes therein, a power source PW718 (power source voltage Vsu), an electric power collecting circuit 716, and transistors Q711 and Q712 for use of switching. Also, the “X” superpose pulse producing circuit 72 for producing the superpose pulse includes therein, a floating power source PW728 (i.e., the power source voltage Vdif with respect to the virtual GND of the “X” superpose pulse producing circuit 72), and transistors Q721 and Q722 for use of switching. And across each of the switching transistors is connected a diode indicated by the reference numerals, D721, D722.

Further, the floating power source can be achieved, easily, by rectifying a high-frequency pulse obtained by, such as, a secondary winding of an insulation transformer (not shown in the figure), for example.

The electric power collecting circuit 616/716 is constructed with the known electric power collecting circuit, wherein it charges the panel capacity of the PDP 1 with an electric power, which was previously collected, when the base pulse P2 rises up, and also it collects the electric power charged into the panel capacity of the PDP 1, when the base pulse P2 falls down.

The scan circuit 63 builds up only a through circuit during the sustain period, and when current flows into the PDP 1, current flows passing through the diodes D631, D633 . . . In case when current flows in from the PDP 1, the transistors Q631, Q633 . . . on a lower side are turned ON, and then current flows into the “Y” superpose pulse producing circuit 62 and the Y” sustain circuit 61 (details thereof will be mentioned later).

Also, the superpose pulse producing circuits 62 and 72 are in the same to the scan circuit 63, during the period of producing no superpose pulse, i.e., current flows through the diodes D621 and D721 when current flows from the sustain circuits 61 and 71 into the PDP 1, the transistors Q621 and Q721 on the lower side are turned ON when current flows in from the PDP 1 (details thereof will be mentioned later).

Next, explanation will be made on the operations of the circuits for superimposing the superpose pulse at the front-end portion of the base pulse P2, by referring to FIG. 5. First of all, production of the base pulse will be mentioned, and the production of the superpose pulse will be mentioned, thereafter.

In FIG. 5, when finishing the period for driving the sustain discharge of the PDP 1 from the “X” electrode side at a time point T₀, the transistor Q631 of the scan circuit 63, the transistor Q621 of the “Y” superpose pulse producing circuit 62, and the transistor Q611 of the “Y” sustain circuits 61 are tuned OFF. And, within a predetermined pause period, it shifts into a next period for driving the sustain discharge of the PDP 1 from the “Y” electrode side, at a time point T₁. When shifting into the period for driving the sustain discharge from the “Y” electrode side, firstly, the transistor Q721 of the “X” superpose pulse producing circuit 72 and the transistor Q711 of the “X” sustain circuits 71 are tuned ON, then the X electrode of the PDP 1 is connected to the GND potential. And, current flows from the electric power collecting circuit 616, passing through the diode D621 of the “Y” superpose pulse producing circuit 62 and the diode D631 of the scan circuit 63, and then the panel capacity (not shown in the figure) of the PDP 1 is charged up. At a time point T₂, when the panel capacity is almost charged up, the transistor Q612 on the upper side of the sustain circuit 61 is turned ON, and the power source voltage Vsu of the power source PW618 is applied onto the PDP 1 until when reaching to a time point T₃. At the time point T₃, the transistor Q612 is turned OFF, and the transistor Q621 of the “Y” superpose pulse producing circuit 62 and the transistor Q631 of the scan circuit 63 are tuned ON, then at this time, the electric power collecting circuit 616 collects the electric power accumulated in the panel capacity, from the PDP 1. The electric power is collected, and at a time point T₄, when the potential of the “Y” electrode of the PDP 1 goes down nearly equal zero (0) V, the transistors Q721 and Q711 are tuned OFF. With such operations, onto the “Y” electrode is applied an output waveform of the “Y” sustain circuit 61, i.e., the base pulse P1. Thereafter, after passing a predetermined pause period, the transistors Q631, Q621, Q611 are tuned ON, at a time point T₅, then the “Y” electrode is connected to the ground, and it shifts into the period for driving the sustain discharge of the PDP 1 from the “X” electrode side.

Next, explanation will be made on production of the superpose pulse P2.

At the time point T₂, the transistor Q612 of the “Y” electrode sustain circuit is turned ON, and after the voltage Vsu is applied onto the PDP 1, the transistor Q622 on the upper side of the “Y” superpose pulse producing circuit 62 is turned on during the time-period t1a, after elapsing the predetermined time-period t0. When the transistor Q622 is turned ON, then the superpose pulse P2, having amplitude of the power source voltage Vd if of the floating power source PW628, is outputted from the “Y” superpose pulse producing circuit 62. This superpose pulse is added (superposed) onto the base pulse P1 outputted from the “Y” sustain circuit 61, thereby building up the narrow-width pulse of high-voltage, having the amplitude (Vsu+Vdif)=Vp. This operation is repeated again, at an interval t1a, and according to the present embodiment, the superpose pulse having the pulse width t1a is produced two (2) times.

As was mentioned above, according to the present embodiment, with producing the base pulse P1 within the sustain circuit (61, 71), with being provided on an output lines of the sustain circuit (61, 71), with producing the superpose pulse P2 within the floating superpose pulse producing circuit, and with additiing (or superimposing) the superpose pulse at the front end portion of the base pulse P1, it is possible to produce a driving waveform of high efficiency of light-emission, as shown in FIG. 1(d).

With use of the superposed pulse of low voltage, not only enabling to use a semiconductor element of high-speed operation therein, but it is also to make it about 60 to 70 V, with which the IC circuit can be achieved.

### Embedment 2

In the embodiment 1, although the superpose pulse producing circuit is provided separating from the scan circuit, within the “Y” drive portion, but the present invention should not be restricted only to this.

According to the present invention, it is possible to bring the amplitude (i.e., the peak value) of the superpose pulse, which is produced within the superpose pulse producer circuit, to be around 60 to 70 V, with which the IC circuit can be achieved. Accordingly, the superpose pulse may be produced within the scan circuit having the floating power source of the voltage value being nearly equal to that.

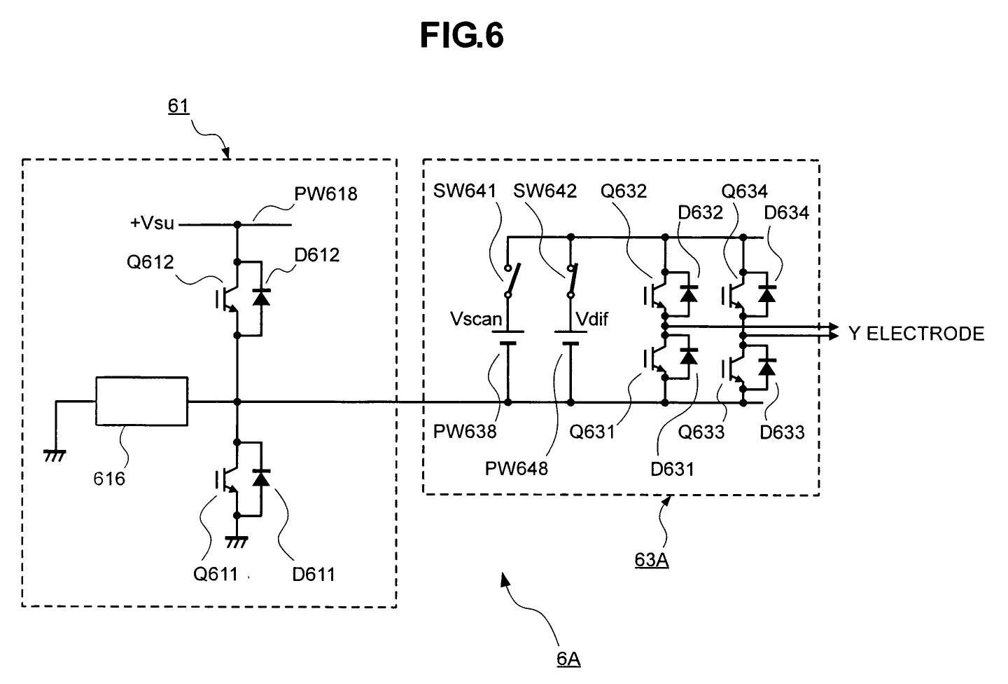

FIG. 6 is the circuit diagram for showing the structures of a principle portion of the “Y” drive portion, according to the present embodiment. However, the elements having the same functions to those shown in FIG. 3 are also shown herein, attached with the same reference numerals thereof, but the repetitive explanation thereof will be omitted.

According to the present embodiment, as is shown in FIG. 6, the “Y” drive portion 6A is built up with the “Y” sustain circuit 61 and a scan circuit 63A.

In addition to the scanning function mentioned in FIG. 3, the scan circuit 63A comprises a superpose pulse producing function. For that reason, it has the floating power source PW638 for use of scanning and a floating power source PW648 for use of producing the superpose pulse, and further switches SW641 and SW642 for exchanging those. Thus, in case when producing the scanning pulse, the switch SW641 is closed, so as to use the power source PW638 having the power source voltage Vscan with respect to the virtual GND, thereby producing a scanning pulse (not shown in the figure) to be supplied to the PDP 1. Also, in case when producing superpose pulse, the switch SW642 is closed, so as to use the power source PW648 having the power source voltage Vdif with respect to the virtual GND, and controls each of the output transistors (for example, Q631, Q632, D631 and D632), in the similar manner to that of the superpose pulse producing circuit shown in FIG. 3, thereby producing the superpose pulse, to be added (superposed) at the front end portion of the base pulse produced within the “Y” sustain circuit 61 and to be supplied to the PDP 1.

However, in case where the voltage Vdif and the voltage Vscan can be made equal to each other, it is also possible to produce the scanning pulse and the superpose pulse, but with using only one (1) floating power source therein.

As was fully explained in the above, according to the present invention, it is possible to drive the PDP of large size, preferably, with using the narrow-width pulse.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A plasma display apparatus, comprising:
an AC-type plasma display panel, which is configured to apply driving voltages, differing from each other in polarity thereof, alternately, at a predetermined time-period, between sustain electrodes building up a pair; and
a sustain discharge drive circuit, which is configured to apply driving voltage for driving said AC-type plasma display panel, alternately, during a sustain discharge period, wherein
a waveform of the driving voltage, which is outputted by said sustain discharge drive circuit, includes a first voltage pulse and a second voltage pulse therein,
said first voltage pulse has a first voltage level and a first pulse width for starting said sustain discharge,
said second voltage has a second voltage level for stopping said sustain discharge, being lower than said first voltage, and a second pulse width, being larger than said first pulse width,
said sustain discharge drive circuit comprises:
a base pulse generating portion, which is configured to generate a base pulse, having said second voltage and corresponding to a total of said first pulse width and said second pulse width; and
a superpose pulse producing portion, which is configured to generate a superpose pulse, having voltage corresponding to a difference between said first voltage level and said second voltage level, and said first pulse width, thereby superposing said superpose pulse at a front end portion of said base pulse.

2. The plasma display apparatus, as described in the claim 1, wherein said first pulse width is shorter than a time-period from starting of said sustain discharge up to self-stoppage thereof, and said second voltage is voltage necessary for stopping said sustain discharge through forming wall electric charges.

3. The plasma display apparatus, as described in the claim 1, wherein a reference potential of said superpose pulse producing portion is floated with respect to a reference potential of said base pulse generating portion.

4. The plasma display apparatus, as described in the claim 1, wherein the superpose pulse formed within said superpose pulse producing portion is made up with a plural number pulses.

5. The plasma display apparatus, as described in the claim 2, wherein the superpose pulse formed within said superpose pulse producing portion is made up with a plural number pulses.

6. The plasma display apparatus, as described in the claim 1, wherein said base pulse generating portion and said superpose pulse producing portion are so constructed to include an active element therein, for each.
